(19) United States
(12) Patent Application Publication
(10) Pub. No.: US 2019/0182198 A1
(43) Pub. Date: Jun. 13, 2019

(54) METHOD AND SYSTEM FOR MANAGING DUPLICATE RECIPIENTS OF AN ELECTRONIC COMMUNICATION

(71) Applicant: TOSHIBA TEC KABUSHIKI KAISHA, Tokyo (JP)

(72) Inventor: Anuj KINNOO, Bangalore (IN)

(73) Assignee: TOSHIBA TEC KABUSHIKI KAISHA, Tokyo (JP)

(21) Appl. No.: 15/987,288

(22) Filed: May 23, 2018

(30) Foreign Application Priority Data
Dec. 12, 2017 (IN) 201741044585

(51) Int. Cl. H04L 12/58

(52) U.S. Cl. CPC H04L 51/28

(57) ABSTRACT

A method and system for managing duplicate recipients of an electronic communication are described. Credentials of all the recipients, selected for transmitting the electronic communication, are compared for detecting duplicate recipients. Further, a notification is provided to a user for notifying the user about presence of duplicate recipients. Finally, the duplicate recipients are retained or deleted based on a user input received in response to the notification. A method helps in dynamically identifying duplicate recipients being selected for transmitting the electronic communication, and alerting the user about presence of the duplicate entries in recipient list. The method facilitates the user in retaining and/or deleting the one or more duplicate entries before transmitting the electronic communication, thereby enhancing overall user experience.

### CROSS-REFERENCE TO RELATED APPLICATION

This application is based upon and claims the benefit of priority from Indian application 201741044585, filed Dec. 12, 2017, the entire contents of which are incorporated by reference.

### TECHNICAL FIELD

The present subject matter is related in general to communication management, more particularly, but not exclusively, to a method and system for managing duplicate recipients of an electronic communication.

### BACKGROUND

Presently, Multi-Function Printers (MFPs) are widely being used across organizations to perform various functions like printing content, scanning the content, electronically transmitting the content to multiple recipients or other connecting devices, and the like. Generally, the MFPs are used by multiple users in the organizations. Most often, users working with the MFPs may register addresses or identifiers of recipients of an electronic transmission under multiple contact names or groups.

As a result, when the same communication/content is being transmitted to multiple destinations, duplications of the destination addresses may be a possible issue, which results in significant monetary loss for the organization over a period of time. The losses may increase further, especially when the electronic communication such as a facsimile, is being sent to an international destination. Alternatively, there may also be scenarios in which it might be necessary for the user to transmit the same content to the same destination address for a multiple number of times. Therefore, there is a need for a method/system which can dynamically determine purpose/necessity of the duplicate destination addresses while transmitting the electronic communication, and thereby effectively managing communications through the MFPs.

### BRIEF DESCRIPTION OF DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 illustrates an exemplary environment for managing duplicate recipients of an electronic communication in accordance with some embodiments of the present disclosure;

FIG. 2 shows a detailed block diagram illustrating a communication manager for managing duplicate recipients of an electronic communication in accordance with some embodiments of the present disclosure;

FIG. 3 illustrates a flowchart for managing duplicate recipients of an electronic communication in accordance with some embodiments of the present disclosure:

FIG. 4A illustrates an exemplary list of recipients in accordance with some embodiments of the present disclosure;

FIG. 4B illustrates an exemplary representation of a user interface associated with the communication manager in accordance with an exemplary embodiment of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration,” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternatives falling within the spirit and the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Disclosed herein is a method for managing duplicate recipients of an electronic communication. The method comprises retrieving, by a communication manager, one or more credentials of each of a plurality of recipients selected for transmitting the electronic communication. Upon retrieving the one or more credentials of each of the plurality of recipients, the method comprises detecting one or more duplicate recipients among the plurality of recipients, based on a comparison among each of the one or more credentials of each of the plurality of recipients. Further, the method comprises providing a notification about presence of the one or more duplicate recipients to a user, associated with the communication manager, upon detecting the one or more duplicate recipients. Finally, the method comprises receiving a user input, in response to the notification, for performing at least one of deletion of the one or more duplicate recipients or retention of the one or more duplicate recipients.

Further, the present disclosure relates to a communication manager for managing duplicate recipients of an electronic communication. The communication manager comprises a processor and a memory. The memory is communicatively coupled to the processor, and stores processor-executable instructions, which on execution, cause the processor to retrieve one or more credentials of each of a plurality of recipients selected for transmitting the electronic communication. Upon retrieving the one or more credentials of each of the plurality of recipients, the instructions cause the processor to detect one or more duplicate recipients among the plurality of recipients based on a comparison among each of the one or more credentials of each of the plurality of recipients. Further, the instructions cause the processor to provide a notification about presence of the one or more duplicate recipients to a user, associated with the communication manager, upon detecting the one or more duplicate recipients. Finally, the instructions cause the processor to receive a user input, in response to the notification, to perform at least one of deletion of the one or more duplicate recipients or retention of the one or more duplicate recipients.

Furthermore, the present disclosure relates to a non-transitory computer readable medium including instructions stored thereon that when processed by at least one processor cause a communication manager to perform operations comprising retrieving one or more credentials of each of a plurality of recipients selected for transmitting the electronic communication. Further, the instructions cause the communication manager to detect one or more duplicate recipients among the plurality of recipients based on a comparison among each of the one or more credentials of each of the plurality of recipients. Upon detecting the one or more duplicate recipients, the instructions cause the communication manager to provide a notification about presence of the one or more duplicate recipients to a user, associated with the communication manager, upon detecting the one or more duplicate recipients. Finally, the instructions cause the communication manager to receive a user input, in response to the notification, for performing at least one of deletion of the one or more duplicate recipients or retention of the one or more duplicate recipients.

The present disclosure relates to a method and a communication manager for managing duplicate recipients of an electronic communication. In some embodiments, the method of present disclosure includes removal of duplicate destination addresses before transmitting the electronic communication. Once the electronic communication is initiated, a list of recipients, which includes the one or more recipients intended to receive the electronic communication, is analysed to detect duplicate entries of recipients/destinations in the recipient list. Upon detecting the duplicate entries in the recipient list, each of the one or more duplicate entries are displayed to user to inform the user about presence of the duplicate recipients. Thereafter, the user may either choose to retain all/some of the duplicate recipients, or delete all the duplicate entries based on the intentions of the user.

In some embodiments, the method of present disclosure dynamically identifies duplicate recipients for the electronic transmission, and alerts a user about presence of the duplicate entries in the recipient list. Thereafter, the user is allowed to either delete and/or retain the one or more duplicate recipients from the recipient list, based on requirements of the user. For example, when more than one copy of the same electronic communication must be transmitted to a single recipient, the user may choose to retain the one or more duplicate entries in the list of recipients. Hence, the present method enhances overall user experience associated with transmission of the electronic transmission. Also, the present method helps in preventing unwanted monetary losses to the user, since all unwanted duplicate entries are filtered out from the list of recipients, before transmitting the electronic communication.

In the following detailed description of the embodiments of the disclosure, reference is made to the accompanying drawings that from a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

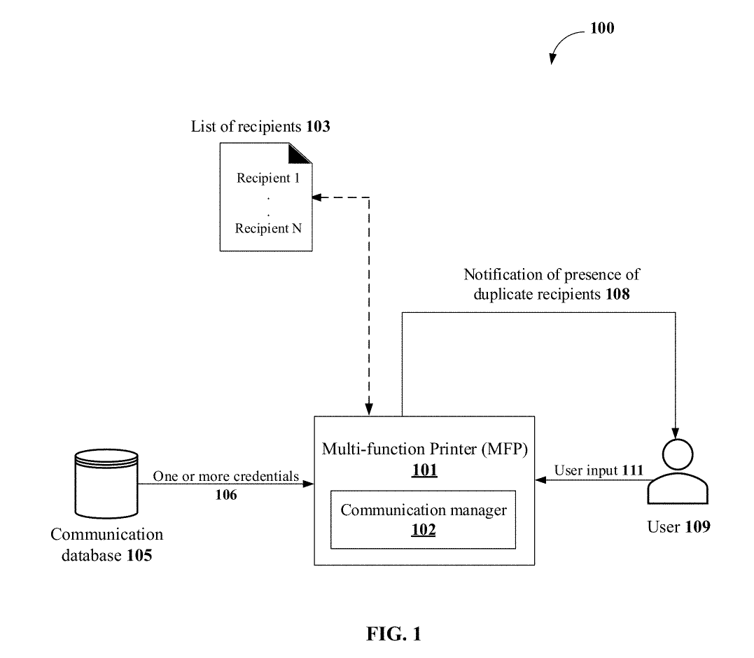

FIG. 1 illustrates an exemplary environment 100 for managing duplicate recipients of an electronic communication in accordance with some embodiments of the present disclosure.

The environment 100 includes a Multi-function printer (MFP) 101, a communication manager 102, a communication database 105, and a user 109. The MFP 101, being referred in various embodiments of the present disclosure, may be an existing general-purpose MFP, which is capable of transmitting an electronic communication to a plurality of recipients selected by the user 109. As an example, the electronic communication may be at least one of, without limitation, an electronic mail (e-mail), a facsimile (FAX), an internet facsimile (iFAX), and a scan-to-email communication. The communication manager 102 may be configured in the MFP 101 for detecting and managing one or more duplicate recipients, among the plurality of recipients, when the electronic communication is initiated at the MFP 101. In an embodiment, each of the plurality of recipients, selected by the user 109, may be stored in the communication manager 102 as a list of recipients 103.

In some embodiments, the communication database 105 may store one or more credentials 106 of each of the plurality of recipients that are registered with the MFP 101 or the communication manager 102. As an example, the one or more credentials 106 may include, without being limited to, electronic mail identifiers (e-mail IDs) of the plurality of recipients, facsimile numbers used by the plurality of recipients, Internet Protocol (IP) destination addresses used by the plurality of recipients, and predefined unique IDs of each of the plurality of recipients. In an implementation, the communication database 105 may be a centralized database, which is stored external to the communication manager 102. Alternatively, the communication database 105 may be stored as a part of the MFP 101 or the communication manager 102.

In some embodiments, when the user 109 initiates transmission of the electronic communication at the MFP 101, the communication manager 102 may retrieve one or more credentials 106 of each of the plurality of recipients, selected by the user 109, from the communication database 105. Further, the communication manager 102 may compare each of the one or more credentials 106 of each of the one or more recipients for detecting one or more duplicate recipients among the plurality of recipients. For example, one or more of the plurality of recipients may be considered to be duplicate when a unique identifier, such as the e-mail ID, of the one or more recipients is same.

In an embodiment, upon determining the one or more duplicate recipients among the plurality of recipients, the communication manager 102 may notify the user 109 about presence of the one or more duplicate recipients, by providing a notification of presence of duplicate recipients 108 (referred to as the notification 108 hereinafter) to the user 109. In an implementation, the notification 108 may be provided to the user 109 through a user interface associated with the communication manager 102. As an example, the user interface may be a display screen, or a touch based display screen associated with the communication manager 102. In other implementations, the notification 108 may be provided to the user 109 through a user device, such as a smartphone, associated with the user 109.

Upon receiving the notification 108, the user 109 may decide to delete each of the one or more duplicate recipients or retain the one or more duplicate recipients based on requirement of the user 109. For example, the user 109 may decide to delete the one or more duplicate recipients from the list of recipients 103, when the one or more duplicate recipients were added accidentally or without the knowledge of the user 109. Alternatively, the user 109 may wish to retain the one or more duplicate recipients in the list of recipients 103, when the user 109 has purposefully added the one or more duplicate recipients to the list of recipients 103.

Accordingly, the user 109 may provide a user input 111 to the communication manager 102. Based on the user input 111, the communication manager 102 may either delete the one or more duplicate recipients, or retain the one or more duplicate recipients. Subsequently, the MFP 101 transmits the electronic communication to each of the plurality of recipients, including one or more retained duplicate recipients, and excluding one or more deleted duplicate recipients. Thus, the communication manager 102 efficiently manages the one or more duplicate recipients with the help of the user input 111.

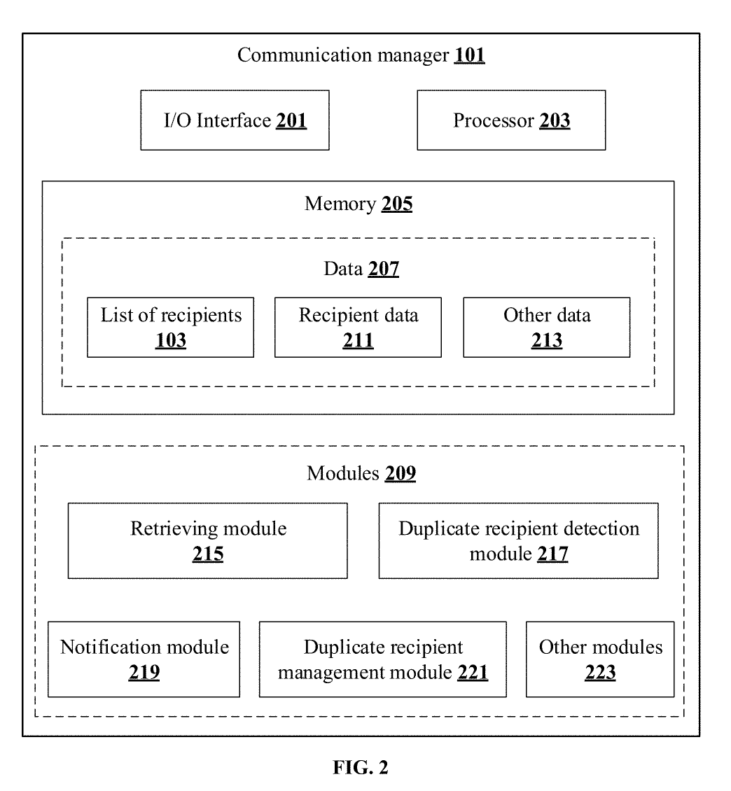

FIG. 2 shows a detailed block diagram illustrating a communication manager 102 for managing duplicate recipients of an electronic communication in accordance with some embodiments of the present disclosure.

The communication manager 102 may include an I/O interface 201, a processor 203, and a memory 205. The I/O interface 201 may be configured to communicate with a communication database 105, associated with the communication manager 102, for retrieving one or more credentials 106 of each of one or more recipients selected for transmitting the electronic communication. The memory 205 may be communicatively coupled to the processor 203. The processor 203 may be configured to perform one or more functions of the communication manager 102 for managing one or more duplicate recipients of the electronic communication.

In some implementations, the communication manger may include data 207 and modules 209 for performing various operations in accordance with the embodiments of the present disclosure. In some embodiments, the data 207 may be stored within the memory 205 and may include, without limiting to, list of recipients 103, recipient data 211, and other data 213.

In some embodiments, the data 207 may be stored within the memory 205 in the form of various data structures. Additionally, the data 207 may be organized using data models, such as relational or hierarchical data models. The other data 213 may store data, including temporary data and temporary files, generated by the modules 209 for performing the various functions of the communication manager 102.

In some embodiments, the list of recipients 103 may include each of the plurality of recipients, who have been selected by the user 109 for transmitting the electronic communication. In some embodiments, the list of recipients 103 may include one or more duplicate recipient entries, when a single recipient is registered and identified by more than one name. Suppose, a single recipient named ‘ABC123’ may be registered under two different recipient groups—‘Group 1’ and ‘Group 2’. In this scenario, when the user 109 selects both the recipient groups, Group 1 and Group 2, for transmitting the electronic communication, the recipient ‘ABC123’ would be added twice in the list of recipients 103. Therefore, the recipient ‘ABC123’ would be considered as a duplicate entry in the list of recipients 103.

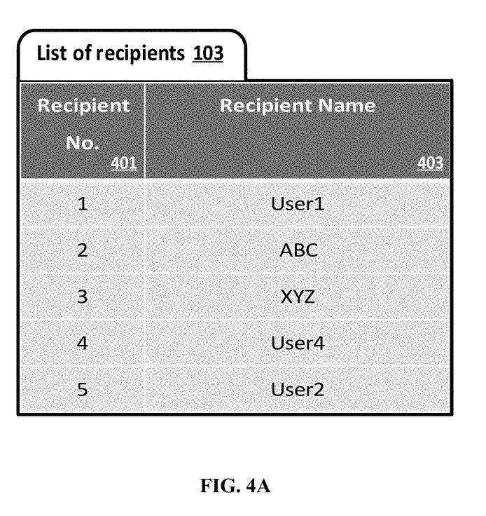

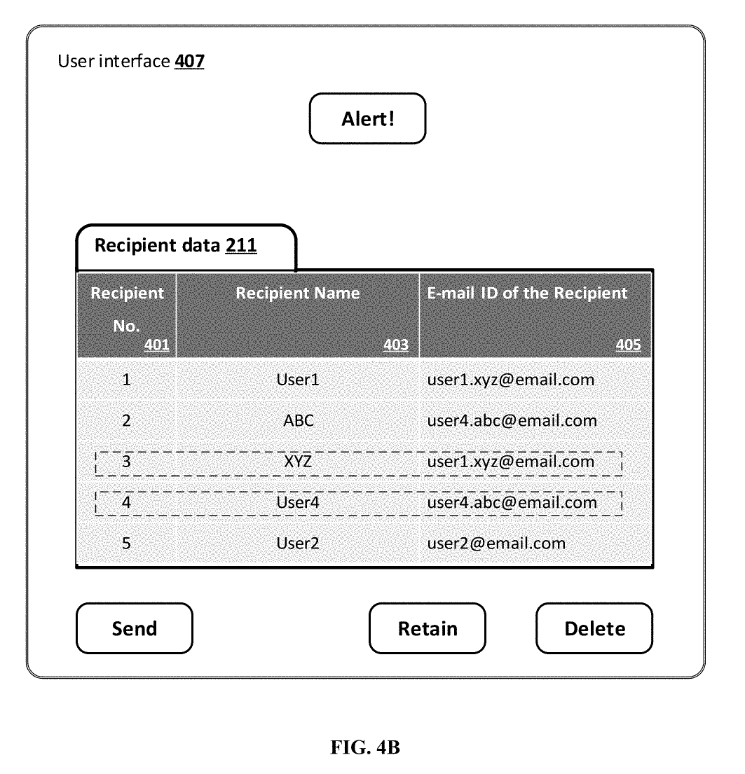

In some embodiments, the one or more credentials 106 of the one or more recipients, included in the list of recipients 103, may be retrieved from the communication database 105 and stored as the recipient data 211 in the communication manager 102. As an example (as shown in FIG. 4B), the recipient data 211 may include information such as, names of each of the plurality of recipients, a unique identifier associated with each of the plurality of recipients, and the like.

In some embodiments, the data 207 may be processed by one or more modules 209 of the communication manager 102. In one implementation, the one or more modules 209 may be stored as a part of the processor 203. In another implementation, the one or more modules 209 may be communicatively coupled to the processor 203 for performing one or more functions of communication manager 102. The modules 209 may include, without being limited to, retrieving module 215, duplicate recipient detection module 217, notification module 219, duplicate recipient management module 221, and other modules 223.

As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 223 may be used to perform various miscellaneous functionalities of the communication manager 102. It will be appreciated that such modules 209 may be represented as a single module or a combination of different modules.

In some embodiments, the retrieving module 215 may be responsible for retrieving the one or more credentials 106 of each of the one or more recipients from the communication database 105, In some implementations, the retrieving module 215 may be configured to retrieve only a selected one of the one or more credentials 106 from the communication database 105 for an optimal retrieval operation. For example, considering resource constraints at the communication manager 102, the retrieving module 215 may retrieve only a single credential, such as a unique identifier of each of the plurality of recipients, instead of retrieving each of the one or more credentials 106, thereby ensuring optimal resource utilization at the communication manager 102.

In some embodiments, the duplicate recipient detection module 217 may be responsible for detecting the one or more duplicate recipients among the plurality of recipients selected by the user 109 for transmitting the electronic communication. The duplicate recipient detection module 217 may compare each of the one or more credentials 106 of each of the plurality of recipients to identify the one or more duplicate recipients.

In some embodiments, the notification module 219 may be responsible for notifying the user 109 about presence of the one or more duplicate recipients in the list of recipients 103, by providing the notification 108 (referred to as the notification 108 hereinafter) to the user 109. The notification 108 may be provided to the user 109 through a user interface associated with the MFP 101 or the communication manager 102 (as shown in FIG. 4B). Alternatively, the notification 108 may be provided to the user 109 through a user device associated with the user 109.

In some embodiments, duplicate recipient management module 221 may be responsible for managing the one or more duplicate recipients based on the user input 111, received in response to the notification 108. The duplicate recipient management module 221 may manage the one or more duplicate recipients by performing at least one of deletion of the one or more duplicate recipients from the list of recipients 103, or retention of the one or more duplicate recipients from the list of recipients 103, based on the user input 111.

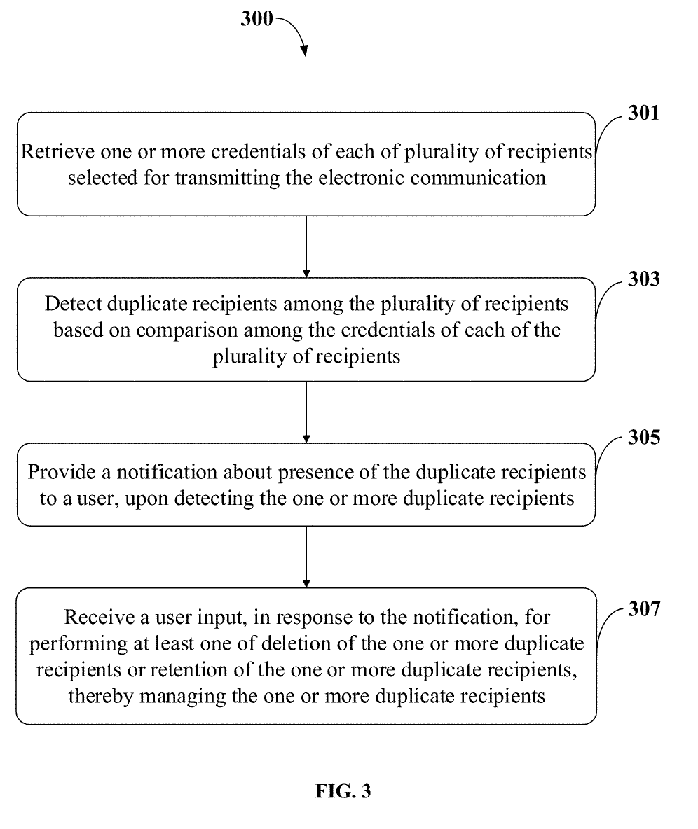

FIG. 3 illustrates a flowchart for managing duplicate recipients of an electronic communication in accordance with some embodiments of the present disclosure.

As illustrated in FIG. 3, the method 300 includes one or more blocks illustrating a method for managing duplicate recipients of an electronic communication using a communication manager 102, for example the communication manager 102 of FIG. 1. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, the method 300 comprises retrieving, by the communication manager 102, one or more credentials 106 of each of plurality of recipients selected for transmitting the electronic communication. As an example, the electronic communication may be at least one of, without limitation, an electronic mail (e-mail), a facsimile (FAX), an internet facsimile (iFAX), and a scan-to-email communication. In an embodiment, the one or more credentials 106 may be stored in a communication database 105 associated with the communication manager 102. As an example, the one or more credentials 106 may include, without being limited to, electronic mail identifiers (e-mail ID)s) of the plurality of recipients, facsimile numbers used by the plurality of recipients, Internet Protocol (IP) destination addresses used by the plurality of recipients, and predefined unique IDs of each of the plurality of recipients.

At block 303, the method 300 comprises detecting, by the communication manager 102, one or more duplicate recipients among the plurality of recipients based on comparison among each of the one or more credentials 106 of each of the plurality of recipients.

At block 305, the method 300 comprises providing, by the communication manager 102, a notification 108 about the presence of the one or more duplicate recipients to a user 109, associated with the communication manager 102, upon detecting the one or more duplicate recipients. In some embodiments, the notification 108 may be provided to the user 109 through a user interface associated with the communication manager 102.

At block 307, the method 300 comprises receiving, by the communication manager 102, a user input 111 in response to the notification 108. Further, based on the user input 111, the communication manager 102 may perform at least one of deletion of the one or more duplicate recipients or retention of the one or more duplicate recipients, thereby managing the one or more duplicate recipients. In some embodiments, the user input 111 may be received from the user 109 through the user interface.

Upon managing the one or more duplicate recipients based on the user input 111, the communication manager 102 may transmit the electronic communication to each of the plurality of recipients, comprising one or more retained duplicate recipients, upon deletion of the one or more other/unwanted duplicate recipients.

### EXEMPLARY EMBODIMENT

Suppose, a user 109 has selected 5 recipients for transmitting an electronic communication through the communication manager 102. In this scenario, a list of recipients 103, including each of the 5 recipients selected by the user 109, may be generated as shown in FIG. 4A. As an example, the list of recipients 103 may indicate number of recipients (referred to as Recipient No. 401) selected by the user 109, and names of each of the 5 recipients (referred to as Recipient Name 403) as registered and saved in the communication manager 102.

In some embodiments, as soon as the user 109 initiates transmission of the electronic communication to the five recipients, thus selected, the communication manager 102 retrieves the one or more credentials 106 of each of the five recipients from the communication database 105 for detecting one or more duplicate recipients among the five recipients selected by the user 109. In the current example, e-mail IDs 405 of each of the five recipients may be retrieved for detecting the one or more duplicate recipients, since the e-mail IDs 405 are universally unique identifiers, and represent each recipient uniquely. The one or more credentials 106, thus retrieved, may be stored as the recipient data 211 as shown in FIG. 4B.

Upon retrieving the e-mail IDs of each of the five user recipients, the communication manager 102 compares e-mail IDs of each of the five recipients and detects the one or more duplicate recipients. In the given example, as shown in FIG. 4B, the recipients named ‘User1’ and ‘XYZ’ may be detected as the duplicate recipients, since the e-mail IDs of the recipients ‘User1’ and ‘XYZ’ is the same e-mail ID—‘userl.xyz@email.com’. Similarly, the recipients named ‘ABC’ and ‘User4’ may be detected as the duplicate recipients, since the e-mail IDs of the recipients ‘ABC’ and ‘User4’ is the same e-mail ID—‘user4.abc@email.com’.

In some embodiments, upon determining the one or more duplicate recipients among the 5 recipients, the communication manager 102 generates an ‘Alert’ to notify the user 109 about the presence of the one or more duplicate recipients. Further, the ‘Alert’ may be displayed to the user 109 through a user interface 407, associated with the communication manager 102. Also, as show in FIG. 4B, the one or more duplicate recipients are displayed as highlighted in the user interface 407, for indicating the one or more duplicate recipients to the user 109. Now, upon receiving the ‘Alert’, the user 109 reviews each of the one or more duplicate recipients, and decides either to retain the one or more duplicate recipients, or to delete the one or more duplicate recipients.

In an embodiment, the user's choice on whether to delete and/or retain the one or more duplicate recipients can be communicated to the communication manager 102 through one or more action buttons—‘Send’, ‘Retain’ or ‘Delete’ as shown in FIG. 4B. For example, if the user 109 selects the ‘Send’ button, then the electronic communication may be transmitted to each of the 5 recipients without making any modifications in the list of recipients 103. Further, by selecting the ‘Retain’ button, the user 109 may retain one or more selected duplicate addresses for transmitting the electronic communication. Similarly, by selecting the ‘Delete’ button, the user 109 may delete one or more selected duplicate addresses before transmitting the electronic communication.

Upon receiving one of the user input 111, as illustrated above, the communication manager 102 performs either deletion and/or retention of the one or more duplicate recipients, thereby effectively managing the one or more duplicate recipients as per requirements of the user 109.

Computer System

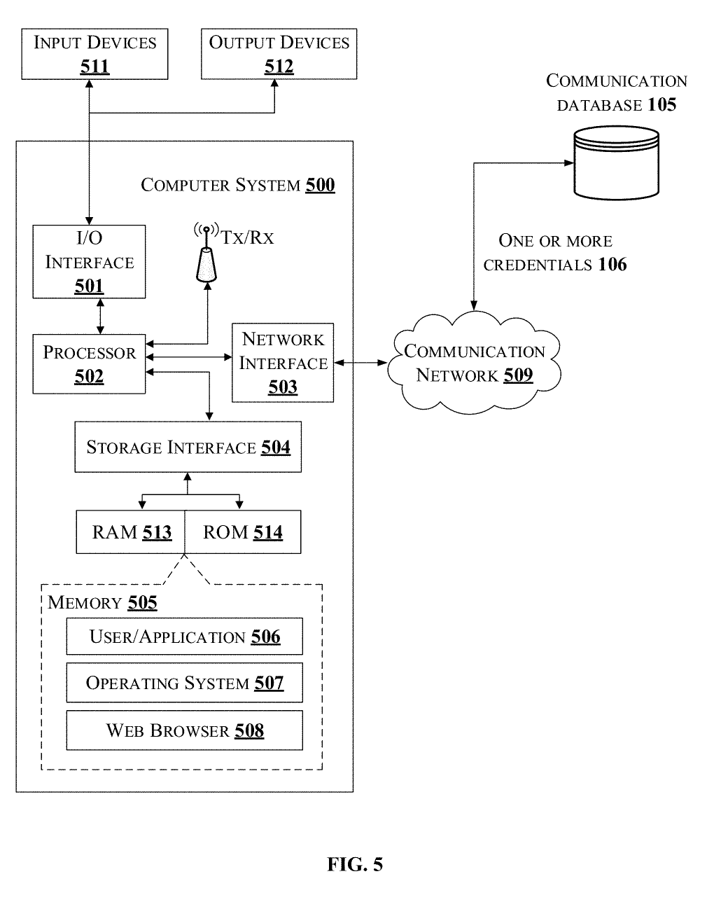

FIG. 5 illustrates a block diagram of an exemplary computer system 500 for implementing embodiments consistent with the present disclosure. In some embodiments, the computer system 500 may be communication manager 102, which is used for managing duplicate recipients of an electronic communication. The computer system 500 may include a central processing unit (“CPU” or “processor”) 502. The processor 502 may comprise at least one data processor for executing program components for executing user- or system-generated business processes. A user may include a person, a person associated with the communication manager 102, a device communicatively connected to the communication manager 102, and the like. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via 1/O interface 501. The I/O interface 501 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 501, the computer system 500 may communicate with one or more I/O devices 511 and 512. In some implementations, the I/O interface 501 may be used to connect to a user device, such as a smartphone associated with the user 109. The user device may be used to provide a notification 108 to the user 109, and to receive a user input 111 from the user 109.

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/gn/x, etc. Using the network interface 503 and the communication network 509, the computer system 500 may communicate with a communication database 105 associated with the communication manager 102 for retrieving one or more credentials 106 related to the plurality of recipients.

The communication network 509 can be implemented as one of the several types of networks, such as intranet or Local Area Network (LAN) and such within the organization. The communication network 509 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In some embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application 506, an operating system 507, a web browser 508, and the like. In some embodiments, computer system 500 may store user/application data 506, such as the data, variables, records, etc. as described. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like.

A user interface may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of Embodiments of the Present Disclosure are Illustrated Herein.

In some embodiments, the present disclosure discloses a method for dynamically identifying one or more duplicate recipients among plurality of recipients selected for transmitting an electronic communication.

In some embodiments, the method of the present disclosure helps in filtering out the one or more duplicate recipients before transmitting the electronic communication, thereby preventing unwanted monetary losses to a user.

In some embodiments, the method of the present disclosure helps in optimal usage of resources such as network bandwidth, printing sheets/papers, and the like by eliminating unwanted redundant electronic communications.

In some embodiments, the method of the present disclosure alerts the user upon detecting the one or more duplicate recipients, and facilitates the user to either delete or retain the one or more duplicate recipients before transmitting the electronic communication, thereby enhancing overall user experience.

In some embodiments, the method of the present disclosure enables the user to transmit multiple copies of a single electronic communication to one or more selected recipients according to requirements of the user and/or the recipients.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERENCE NUMERALS

| Reference Number | Description |
|---|---|
| 100 | Environment |
| 101 | Multi-function Printer (MFP) |
| 102 | Communication manager |
| 103 | List of recipients |
| 105 | Communication database |
| 106 | One or more credentials |
| 108 | Notification of presence of duplicate recipients |
| 109 | User |
| 111 | User input |
| 201 | I/O interface |
| 203 | Processor |
| 205 | Memory |
| 207 | Data |
| 209 | Modules |
| 211 | Recipient data |
| 213 | Other data |
| 215 | Retrieving module |
| 217 | Duplicate recipient detection module |
| 219 | Notification module |
| 221 | Duplicate recipient management module |
| 223 | Other modules |
| 401 | Recipient number |
| 403 | Recipient name |
| 405 | E-mail ID of the recipient |
| 407 | User interface |
| 500 | Exemplary computer system |
| 501 | I/O Interface of the exemplary computer system |
| 502 | Processor of the exemplary computer system |
| 503 | Network interface |
| 504 | Storage interface |
| 505 | Memory of the exemplary computer system |
| 506 | User/Application |
| 507 | Operating system |
| 508 | Web browser |
| 509 | Communication network |
| 511 | Input devices |
| 512 | Output devices |
| 513 | RAM |
| 514 | ROM |

What is claimed is:

1. A method for managing duplicate recipients of an electronic communication, the method comprising:
retrieving, by a communication manager, one or more credentials of each of a plurality of recipients selected for transmitting the electronic communication;
detecting, by the communication manager, one or more duplicate recipients among the plurality of recipients based on a comparison among each of the one or more credentials of each of the plurality of recipients;
providing, by the communication manager, a notification about presence of the one or more duplicate recipients to a user, associated with the communication manager, upon detecting the one or more duplicate recipients; and
receiving, by the communication manager, a user input, in response to the notification, for performing at least one of deletion of the one or more duplicate recipients or retention of the one or more duplicate recipients.

2. The method as claimed in claim 1, wherein the electronic communication is at least one of an electronic mail (e-mail), a facsimile (FAX), an internet facsimile (iFAX), or a scan-to-email communication.

3. The method as claimed in claim 1, wherein the one or more credentials are stored in a communication database associated with the communication manager.

4. The method as claimed in claim 1, wherein the one or more credentials comprises at least one of electronic mail identifiers (e-mail IDs) of the plurality of recipients, facsimile numbers used by the plurality of recipients, Internet Protocol (IP) destination addresses used by the plurality of recipients, or predefined unique IDs of each of the plurality of recipients.

5. The method as claimed in claim 1, wherein the notification is provided to the user through a user interface associated with the communication manager.

6. The method as claimed in claim 5, wherein the user input is received from the user, through the user interface.

7. The method as claimed in claim 1, wherein the electronic communication is transmitted to each of the plurality of recipients, comprising one or more retained duplicate recipients, upon deletion of the one or more duplicate recipients.

8. A communication manager for managing duplicate recipients of an electronic communication, the communication manager comprising:
a processor,
a memory, communicatively coupled to the processor, wherein the memory stores processor-executable instructions, which, on execution cause the processor to:
retrieve one or more credentials of each of a plurality of recipients selected for transmitting the electronic communication;
detect one or more duplicate recipients among the plurality of recipients based on a comparison among each of the one or more credentials of each of the plurality of recipients;
provide a notification about presence of the one or more duplicate recipients to a user, associated with the communication manager, upon detecting the one or more duplicate recipients; and
receive a user input, in response to the notification, to perform at least one of deletion of the one or more duplicate recipients or retention of the one or more duplicate recipients.

9. The communication manager as claimed in claim 8, wherein the electronic communication is at least one of an electronic mail (e-mail), a facsimile (FAX), an internet facsimile (iFAX), or a scan-to-email communication.

10. The communication manager as claimed in claim 8, wherein the instructions cause the processor to store the one or more credentials in a communication database associated with the communication manager.

11. The communication manager as claimed in claim 8, wherein the one or more credentials comprises at least one of electronic mail identifiers (e-mail IDs) of the plurality of recipients, facsimile numbers used by the plurality of recipients, Internet Protocol (IP) destination addresses used by the plurality of recipients, or predefined unique IDs of each of the plurality of recipients.

12. The communication manager as claimed in claim 8, wherein the instructions cause the processor to provide the notification to the user through a user interface associated with the communication manager.

13. The communication manager as claimed in claim 12, wherein the instructions cause the processor to receive the user input, from the user, through the user interface.

14. The communication manager as claimed in claim 8, wherein the instructions cause the processor to transmit the electronic communication to each of the plurality of recipients, comprising one or more retained duplicate recipients, upon deletion of the one or more duplicate recipients.

15. A non-transitory computer readable medium including instructions stored thereon that when processed by at least one processor cause a communication manager to perform operations comprising:
retrieving one or more credentials of each of a plurality of recipients selected for transmitting the electronic communication;
detecting one or more duplicate recipients among the plurality of recipients based on a comparison among each of the one or more credentials of each of the plurality of recipients;
providing a notification about presence of the one or more duplicate recipients to a user, associated with the communication manager, upon detecting the one or more duplicate recipients; and
receiving a user input, in response to the notification, for performing at least one of deletion of the one or more duplicate recipients or retention of the one or more duplicate recipients.

16. The non-transitory computer readable medium as claimed in claim 15, wherein the electronic communication is at least one of an electronic mail (e-mail), a facsimile (FAX), an internet facsimile (iFAX), or a scan-to-email communication.

17. The non-transitory computer readable medium as claimed in claim 15, wherein the instructions cause the communication manager to store the one or more credentials in a communication database associated with the communication manager.

18. The non-transitory computer readable medium as claimed in claim 15, wherein the one or more credentials comprises at least one of electronic mail identifiers (e-mail IDs) of the plurality of recipients, facsimile numbers used by the plurality of recipients, Internet Protocol (IP) destination addresses used by the plurality of recipients, or predefined unique IDs of each of the plurality of recipients.

19. The non-transitory computer readable medium as claimed in claim 15, wherein the instructions cause the communication manager to provide the notification to the user through a user interface associated with the communication manager.

20. The non-transitory computer readable medium as claimed in claim 15, wherein the instructions cause the communication manager to transmit the electronic communication to each of the plurality of recipients, comprising one or more retained duplicate recipients, upon deletion of the one or more duplicate recipients.
